(19) United States
(12) Patent Application Publication
(10) Pub. No.: US 2010/0128790 A1
(43) Pub. Date: May 27, 2010

(54) MOTION COMPENSATION DEVICE

(75) Inventor: Masahiro KOANA, Kanagawa (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: KABUSHIKI KAISHA TOSHIBA, Tokyo (JP)

(21) Appl. No.: 12/553,569

(22) Filed: Sep. 3, 2009

(30) Foreign Application Priority Data
Nov. 27, 2008 (JP) 2008-302865

(51) Int. Cl. H04N 7/26

(52) U.S. Cl. 375/240.16; 375/E07.124

(57) ABSTRACT

A motion compensation device includes a counter unit that counts the number of input frames, a rounding-direction control unit that determines, based on whether the number of counts is odd or even, a rounding direction during reduction of a motion vector, a MV-conversion processing unit that applies, after the motion vector is reduced, rounding processing to a value of the motion vector after the reduction, and a decoded-image creating unit that creates a decoded image from a predicted image created by using the motion vector after the rounding processing and a reference image.

### CROSS-REFERENCE TO RELATED APPLICATIONS

This application is based upon and claims the benefit of priority from the prior Japanese Patent Application No. 2008-302865, filed on Nov. 27, 2008; the entire contents of which are incorporated herein by reference.

### BACKGROUND OF THE INVENTION

1. Field of the Invention

The present invention relates to a motion compensation device.

2. Description of the Related Art

In recent years, according to the spread of digital broadcasts and the progress of digital apparatuses, opportunities of treating high-resolution videos are increasing. In the digital broadcasts, high-definition (HD) size programs are broadcasted. With digital video cameras for personal use, photographing at full HD resolution can be performed. A display that can display HD contents dot by dot is costly because an expensive display is expensive and requires a decoding processing device having high performance (a memory capacity, band width, and processing ability). When the display is used in a portable apparatus, there are strict restrictions concerning size, power consumption, and the like because of uses of the portable apparatus.

For example, when a high-resolution video is displayed in the portable apparatus, based on the provisions described in Nonpatent Documents 1 to 3, an entire frame is not subjected to reduction filter processing to reduce display size after being decoded but is subjected to the reduction filter processing at a stage of decoding processing and the decoding processing is performed by using a reduced reference image and a reduced motion vector. It is possible to hold down the performance of the decoding processing device and reduce cost by performing such processing.

However, according to the related art, for example, when image size in the horizontal direction is halved, the reference image and the motion vector are also halved in the horizontal direction. This is equivalent to a loss of accuracy for least significant 1 bit of the motion vector. Therefore, when motion compensation is performed, a pixel position that should be referred to shifts, errors are accumulated in a reference image to be created anew, and an object in an image looks quickly moving when the object moves to an intra-screen prediction frame.

When the reduced reference image and the reduced motion vector are used and the accuracy of the motion vector is ½ pel, the accuracy of the motion vector can be secured by reading the accuracy as ¼ pel as a method of halving the motion vector. However, in this case, it is necessary to linearly interpolate pixels of the reference image to ¼ pel accuracy different from accuracy during encoding. Therefore, a calculation amount more than that specified in the standard is necessary.

The present invention has been devised in view of the problems and it is an object of the present invention to provide a motion compensation device that suppresses, in performing decoding processing using a reduced reference image, an increase in a calculation amount in motion compensation to obtain a high-quality image while reducing deterioration in the accuracy of a motion vector.

### BRIEF SUMMARY OF THE INVENTION

A motion compensation device according to an embodiment of the present invention comprises: a counter unit that counts a number of input frames; a rounding-direction control unit that determines, in reducing a motion vector, based on whether the number of counts by the counter unit is odd or even, a rounding direction of rounding processing for converting a value of the motion vector into specified accuracy; a motion vector (MV)-conversion processing unit that reduces the motion vector and applies, based on the rounding direction determined by the rounding-direction control unit, the rounding processing to a value of the motion vector after the reduction; and a decoded-image creating unit that creates a predicted image using the motion vector after the rounding processing and a decoded image in the past, which is the reference image, and creates a decoded image based on the predicted image.

A motion compensation device according to an embodiment of the present invention comprises: an error-value counter unit that calculates a difference between a value obtained by shifting a reduced motion vector to accuracy before the reduction and a value of the motion vector before the reduction and calculates a cumulative value of the difference; a rounding-direction control unit that determines, in reducing a motion vector, based on the cumulative value of the difference calculated by the error-value counter unit, a rounding direction of rounding processing for converting a value of the motion vector into specified accuracy; a motion vector (MV)-conversion processing unit that reduces the motion vector and applies, based on the rounding direction determined by the rounding-direction control unit, the rounding processing to a value of the motion vector after the reduction; and a decoded-image creating unit that creates a predicted image using the motion vector after the rounding processing and a decoded image in the past, which is the reference image, and creates a decoded image based on the predicted image.

A motion compensation device according to an embodiment of the present invention comprises: an error-value counter unit that, as rounding processing for converting a value of a motion vector into specified accuracy, calculates, concerning two rounding directions in rounding a value of the motion vector in a + direction and rounding the value in a − direction, a difference between a value obtained by shifting a reduced motion vector to accuracy before the reduction and a value of the motion vector before the reduction and calculates a cumulative value of the difference; a rounding-direction control unit that determines, in reducing the motion vector, based on an absolute value of the cumulative value of the difference calculated when the rounding processing is performed in the + direction and an absolute value of the cumulative value of the difference calculated when the rounding processing is performed in the − direction; a motion vector (MV)-conversion processing unit that reduces the motion vector and applies, based on the rounding direction determined by the rounding-direction control unit, the rounding processing to a value of the motion vector after the reduction; and a decoded-image creating unit that creates a predicted image using the motion vector after the rounding processing and a decoded image in the past, which is the reference image, and creates a decoded image based on the predicted image.

### BRIEF DESCRIPTION OF THE DRAWINGS

FIG. 1 is a block diagram of a configuration example of a decoding processing device according to a first embodiment of the present invention;

FIG. 2 is a block diagram of a configuration example of a motion compensation unit according to the first embodiment;

FIG. 3 is a flowchart of motion compensation processing according to the first embodiment;

FIGS. 4A and 4B are diagrams for explaining rounding processing for a motion vector;

FIG. 5 is a block diagram of a configuration example of a motion compensation unit according to a second embodiment of the present invention;

FIG. 6 is a flowchart of motion compensation processing according to the second embodiment;

FIG. 7 is a block diagram of a configuration example of a motion compensation unit according to a third embodiment of the present invention;

FIG. 8 is a flowchart of motion compensation processing according to the third embodiment;

FIG. 9 is a block diagram of a configuration example of a motion compensation unit according to a fourth embodiment of the present invention;

FIG. 10 is a flowchart of motion compensation processing according to the fourth embodiment;

FIG. 11 is a block diagram of a configuration example of a motion compensation unit according to a fifth embodiment of the present invention; and

FIG. 12 is a flowchart of motion compensation processing according to the fifth embodiment.

### DETAILED DESCRIPTION OF THE INVENTION

Exemplary embodiments of motion compensation device according to the present invention will be explained below in detail with reference to the accompanying drawings. The present invention is not limited to the following embodiments.

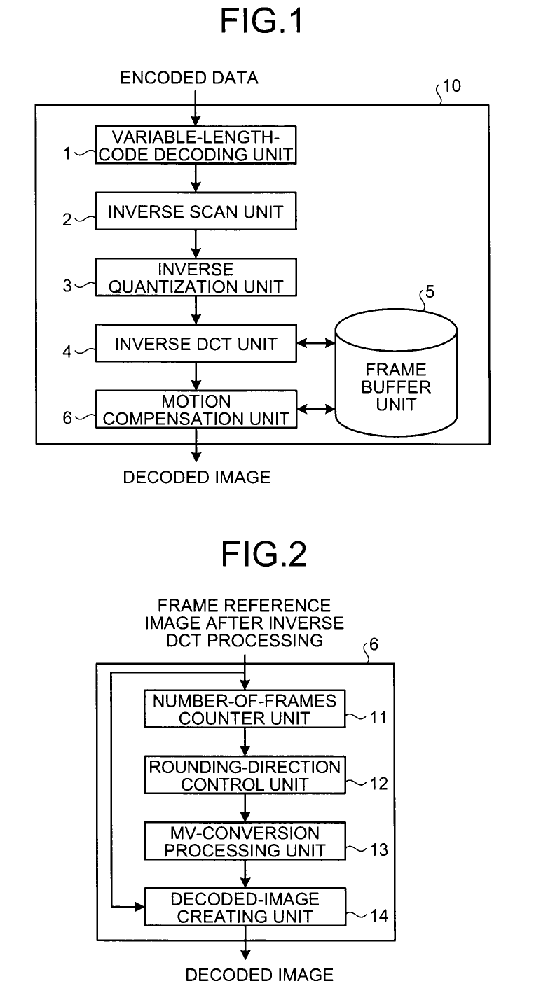

FIG. 1 is a block diagram of a configuration example of a decoding processing device according to a first embodiment of the present invention that performs decoding processing for a moving image. The decoding processing device 10 includes a variable-length-code decoding unit 1, an inverse scan unit 2, an inverse quantization unit 3, an inverse discrete cosine transform (DCT) unit 4, a frame buffer unit 5, and a motion compensation unit 6.

In the decoding processing device 10, when encoded data is input, the variable-length-code decoding unit 1 applies decoding of a variable length code to the encoded data and extracts various parameters, flags, motion vectors, and DCT coefficients. The inverse scan unit 2 applies rearrangement processing to the extracted DCT coefficients. Then, the inverse quantization unit 3 applies inverse quantization processing to the DCT coefficients and the inverse DCT unit 4 applies inverse DCT processing to the DCT coefficients.

Motion compensation is not applied to a frame for which intra-screen prediction is performed. Therefore, the inverse DCT unit 4 transfers the frame to the frame buffer unit 5 and stores the frame therein to use the frame as a reference image later. The frame for the intra-screen prediction is directly used as a decoded image. Motion compensation is applied to a frame for which inter-screen prediction is performed. Therefore, the discrete DCT unit 4 transfers the frame to the motion compensation unit 6. The motion compensation unit 6 creates a predicted image using the reference image stored in the frame buffer unit 5 and the motion vector and adds up residuals obtained by the inverse quantization and the inverse DCT processing to obtain a decoded image. After creating the decoded image, the motion compensation unit 6 transfers the decoded image to the frame buffer unit 5 and stores the decoded image therein to use the decoded image as a reference image later.

In this embodiment, motion compensation is performed by using a reference image having size different from that of a reference image used during encoding. Therefore, the reference image is converted into desired size before the motion compensation is performed. For example, when the frame for the intra-screen prediction is converted into a half size in the horizontal direction, in performing the inverse DCT processing, the inverse DCT unit 4 reduces orders to 4×8 with a high-frequency component set to 0 and performs the inverse DCT processing to obtain a reduced image rather than performing normal 8×8 inverse DCT processing. The inverse DCT unit 4 transfers the reduced image to the frame buffer unit 5 and stores the reduced image therein as a reference image. In the following explanation, the reference image is reduced to a half in the horizontal direction (an x direction). The accuracy of a motion vector is ½ pel at a stage before the reduction (during encoding).

The motion compensation unit 6 performs processing for reducing a rounding error of a motion vector. In this embodiment, the motion compensation unit 6 reduces deviation of the rounding error by changing a rounding direction of the motion vector based on whether the number of frames input to the motion compensation unit 6 is odd or even. The motion vector is in macro-block units.

FIG. 2 is a block diagram of a configuration example of the motion compensation unit 6 according to this embodiment. The motion compensation unit 6 includes a number-of-frames counter unit 11, a rounding-direction control unit 12, a motion vector (MV) conversion processing unit 13, and a decoded-image creating unit 14. The number-of-frames counter unit 11 counts the number of input frames (frames subjected to inverse DCT processing). The rounding-direction control unit 12 determines a rounding direction of a motion vector based on whether the counted number of frames is odd or even. The MV-conversion processing unit 13 performs rounding processing for the motion vector based on the determination of the rounding-direction control unit 12 and outputs a halved motion vector. The decoded-image creating unit 14 creates a predicted image using a reference image and the motion vector and adds a residual of the inverse DCT processing to the predicted image to obtain a decoded image.

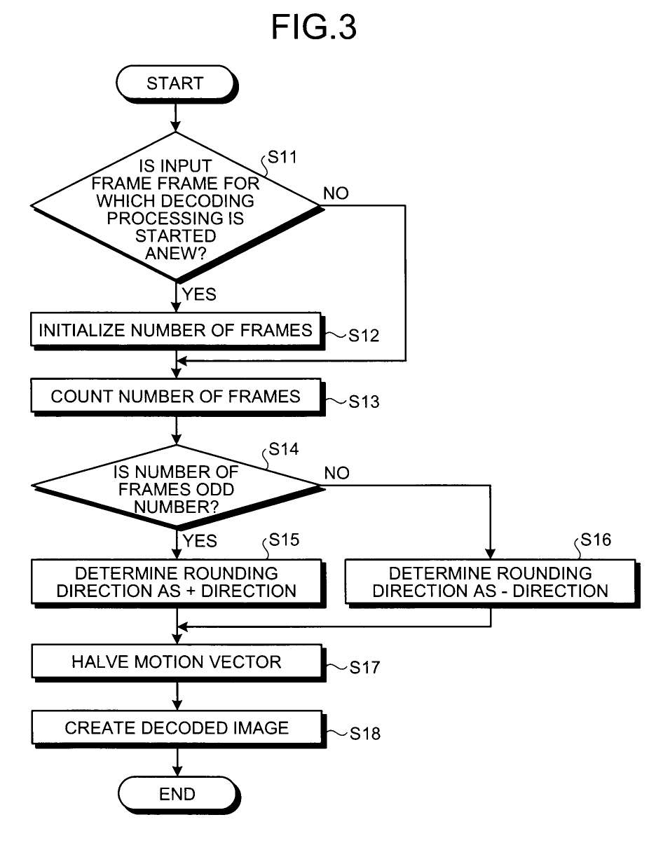

FIG. 3 is a flowchart of motion compensation processing performed by the motion compensation unit 6 according to this embodiment. First, the number-of-frames counter unit 11 checks whether an input frame is a frame for which decoding processing is started anew (step S11). When the decoding processing is started anew for the frame (“Yes” at step S11), the number-of-frames counter unit 11 initializes the number of frames (frameNum=0) (step S12) and counts the number of frames (step S13). When the input frame is not a frame for which the decoding processing is started anew (“No” at step S11), the number-of-frames counter unit 11 counts the number of frames without initializing the number of frames (step S13).

Subsequently, the rounding-direction control unit 12 determines a rounding direction (roundXDirection) in halving a motion vector in view of whether a lower order 1 bit of the number of frames counted by the number-of-frames counter unit 11 is odd or even (steps S14 to S16). Specifically, when the number of frames is an odd number (frameNum&1) (“Yes” at step S14), the rounding-direction control unit 12 determines that a motion vector with ¼ pel accuracy is rounded in a + direction (“roundXDirection=1”) (step S15). When the number of frames is an even number (“No” at step S14), the rounding-direction control unit 12 determines that the motion vector with ¼ pel accuracy is rounded in a − direction (“roundXDirection=0”) (step S16).

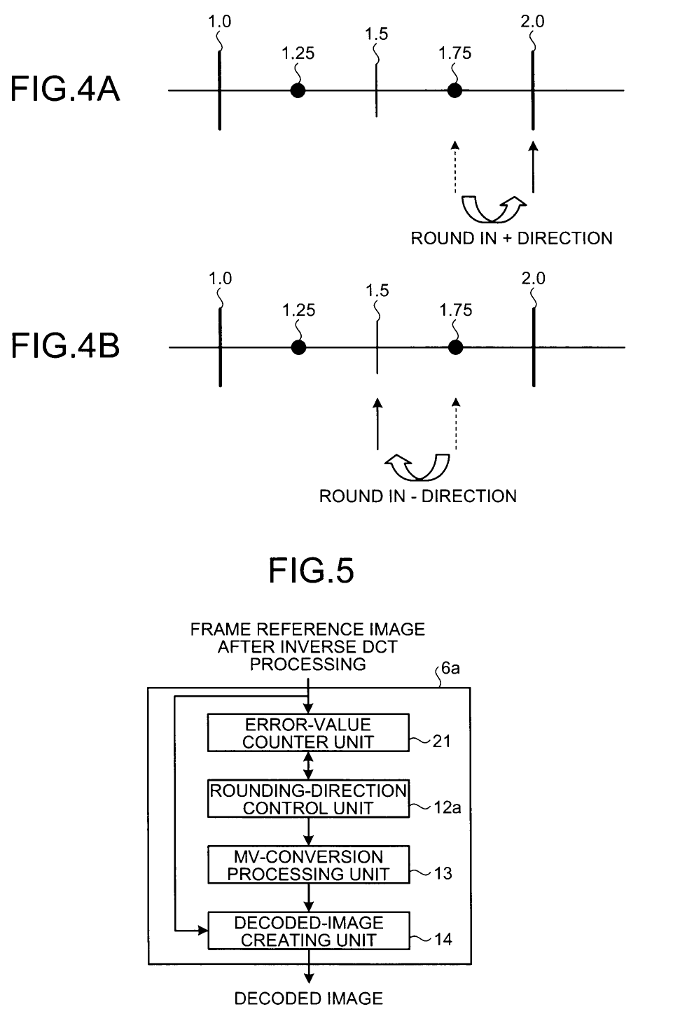

FIGS. 4A and 4B are diagrams for explaining rounding processing for a motion vector. Originally, when a motion vector with ½ pel accuracy is halved, a halved motion vector has ¼ pel accuracy. The rounding processing indicates a rounding direction in correcting ¼ pel accuracy to ½ pel accuracy. For example, when a motion vector (mvx)=3.5 is halved, mvx=1.75 is obtained. Rounding mvx=1.75 in the + direction is equivalent to rounding the value 1.75 to 2.0 (FIG. 4A). On the other hand, rounding mvx=1.75 in the − direction is equivalent to rounding the value 1.75 to 1.5 (FIG. 4B). By performing such rounding processing, a motion vector with ¼ (0.25) pel accuracy can be corrected to ½ (0.5) pel accuracy. Therefore, accuracy same as that during encoding can be secured.

The MV-conversion processing unit 13 applies, based on the determination of the rounding-direction control unit 12, rounding processing for a lower order 1 bit to a motion vector (mvx) obtained when encoded data is decoded and outputs a halved motion vector (mvxh) (step S17). The motion vector (mvxh) is used in creating a predicted image and a decoded image. The output halved motion vector (mvxh) can be calculated by adding a value of “roundXDirection” determined by the rounding-direction control unit 12 to an original value of the motion vector (mvx) and then performing processing for shifting the motion vector in the right direction by 1 bit. In other words, the halved motion vector can be represented as “mvxh=(mvx+roundXDirection)>>1”.

Finally, the decoded-image creating unit 14 creates a predicted image using the halved motion vector (mvxh) output from the MV-conversion processing unit 13 and the reference image stored in the frame buffer unit 5. Further, the decoded-image creating unit 14 obtains a decoded image by adding the residual of the inverse DCT to the predicted image to obtain a decoded image (step S18). A method of creating the predicted image and the decoded image is the same as that in the past.

According to the processing explained above, because errors are not accumulated in a specific direction in halving a motion vector, errors are not accumulated in the reference image either. Therefore, it is possible to prevent a state in which it looks as if an object in an image suddenly moves when the object moves from an inter-screen prediction frame to an intra-screen prediction frame.

As explained above, in this embodiment, a direction of the rounding processing performed in reducing a motion vector is determined according to whether the number of frames is odd or even. This makes it possible to reduce, even when motion compensation is performed by using a reduced reference image, accumulation of errors of the motion vector without increasing a calculation amount and obtain a high-quality image while maintaining the accuracy of the motion vector.

The rounding-direction control unit 12 determines that the motion vector is rounded in the + direction when the number of frames is an odd number and determines that the motion vector is rounded in the − direction when the number of frames is an even number. However, the rounding directions are not limited to this and can be set in opposite directions, respectively.

In a second embodiment of the present invention, rounding errors of a motion vector for each of macro blocks in a frame are accumulated and, when a cumulative error value exceeds an allowable range, a rounding direction of the motion vector is changed to reduce deviation of the rounding errors. Differences from the first embodiment are explained below.

FIG. 5 is a block diagram of a configuration example of a motion compensation unit 6a according to this embodiment. The motion compensation unit 6a includes an error-value counter unit 21, a rounding-direction control unit 12a, the MV-conversion processing unit 13, and the decoded-image creasing unit 14. The error-value counter unit 21 calculates a difference (an error) between a value of a motion vector before being halved and a value obtained by shifting the motion vector after being halved in the left direction by 1 bit and calculates a cumulative value of errors. The rounding-direction control unit 12a determines a rounding direction of the motion vector based on a comparison result of the cumulative value of errors and an allowable error range. In this embodiment, the decoding processing device 10 includes the motion compensation unit 6a instead of the motion compensation unit 6 shown in FIG. 1.

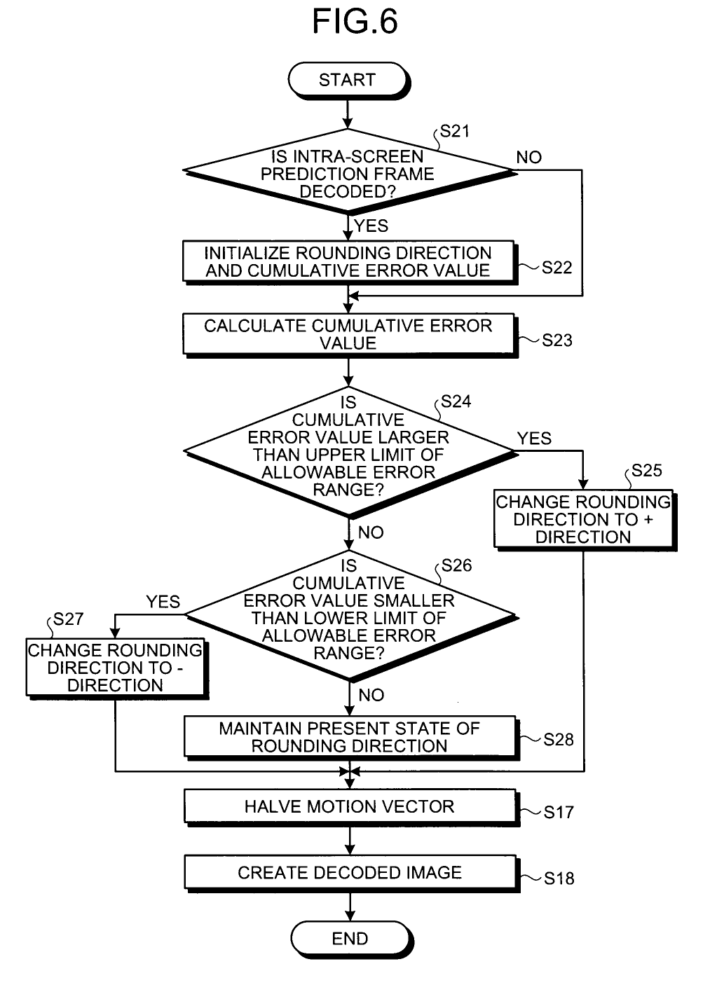

Motion compensation processing performed by the motion compensation unit 6a is explained in detail with reference to a flowchart. FIG. 6 is a flowchart of the motion compensation processing according to this embodiment. First, the error-value counter unit 21 checks whether an intra-screen prediction frame is decoded (step S21). When the intra-screen prediction frame is decoded (“Yes” at step S21), the error-value counter unit 21 performs initialization of a rounding direction and a cumulative error value at the start of decoding processing (step S22). As initial setting, the rounding direction is set in the − direction (“roundXDirection=0”). Further, the error-value counter unit 21 performs initialization (totalError=0) of a cumulative error value (totalError) obtained by accumulating a difference (an error) between a value obtained by shifting a motion vector halved in the horizontal direction (mvxh) in the left direction by 1 bit and a value of an original motion vector (mvx) before being halved. When the intra-screen prediction frame is not decoded (“No” at step S21), the processing at step S22 is omitted.

As provisional processing, the error-value counter unit 21 calculates, after the start of processing for motion compensation, the halved motion vector (mvxh) based on the rounding direction (the − direction) set in the initial setting and further calculates a value (mvxh<<1) obtained by shifting the halved motion vector (mvxh) in the left direction by 1 bit. Thereafter, the error-value counter unit 21 calculates, for each of motion vectors of a macro block, a difference (mvx−(mvxh<<1)) between the value (mvxh<<1) obtained by shifting the halved motion vector (mvxh) in the left direction by 1 bit and a value of the original motion vector (mvx) before being halved and adds up calculated differences to calculate a cumulative error value (totalError) (step S23). When notification for changing the rounding direction is received from the rounding-direction control unit 12a, the error-value counter unit 21 changes the rounding direction in the processing (step S23) based on the notification.

Subsequently, the rounding-direction control unit 12a compares the cumulative error value (totalError) calculated by the error-value counter unit 21 and an allowable error range set in advance (steps S24 and S26). The allowable error range is an allowable range of errors that can be set based on image size, a maximum number of motion vectors, and the like when errors of a motion vector calculated for each of macro blocks are accumulated.

Specifically, when the cumulative error value (totalError) is larger than an upper limit of the allowable error range (“Yes” at step S24), the rounding-direction control unit 12a changes the rounding direction to the + direction (“roundXDirection=1”) (step S25). When the cumulative error value (totalError) is equal to or smaller than the upper limit of the allowable error range (“No” at step S24), the rounding-direction control unit 12a determines whether the cumulative error value (totalError) is smaller than a lower limit of the allowable error range (step S26). When the cumulative error value (totalError) is smaller than the lower limit of the allowable error range (“Yes” at step S26), the rounding-direction control unit 12a changes the rounding direction to the − direction (“roundXDirection=0”) (step S27). When the cumulative error value (totalError) is equal to or larger than the lower limit of the allowable error range (“No” at step S26), the rounding-direction control unit 12a does not change the rounding direction and maintains the present state (step S28).

The rounding-direction control unit 12a notifies the error-value counter unit 21 and the MV-conversion processing unit 13 of the determined rounding direction of the motion vector. Timing for changing the rounding direction is in frame units (when the cumulative error value (totalError) deviates from the allowable error range, the rounding direction is changed for a frame to be subjected to decoding processing next).

Processing for outputting the halved motion vector (mvxh) performed by the MV-conversion processing unit 13 (step S17) and processing for creating a decoded image performed by the decoded-image creating unit 14 (step S18) are the same as those in the first embodiment.

In this embodiment, when a motion vector is halved, a rounding direction of the motion vector is changed when predetermined errors are accumulated in a specific direction in each of frames. Therefore, it is possible to prevent a state in which it looks as if an object in an image suddenly moves when the object moves to an intra-screen prediction frame.

As explained above, in this embodiment, a direction of rounding processing performed in reducing a motion vector is determined based on a cumulative value of errors that occur when the motion vector is reduced. This makes it possible to reduce, even when motion compensation is performed by using a reduced reference image, accumulation of errors of the motion vector without increasing a calculation amount and obtain a high-quality image while maintaining the accuracy of the motion vector.

In the processing explained above, the error-value counter unit 21 performs the processing for halving a motion vector to calculate a cumulative error value. However, the processing is not limited to this. For example, the error-value counter unit 21 can use a motion vector halved by the MV-conversion processing unit 13. The motion vector is not limited to a motion vector in macro block units and can be motion vectors in units of other areas such as a sub-macro block.

In the processing explained above, the rounding direction is changed when the cumulative error value (totalError) deviates from the allowable error range. However, the change of the rounding direction is not limited to this. For example, when the cumulative error value (totalError) is positive, the rounding direction can be changed to the + direction (“roundXDirection=1”) and, when the cumulative error value (totalError) is negative, the rounding direction can be changed to the − direction (“roundXDirection=0”). When the cumulative error value (totalError) is zero, the rounding direction is not changed. In this case, timing for changing the rounding direction is not in frame units but in macro block units. Consequently, the rounding direction can be changed to a direction for reducing the cumulative error value. Therefore, it is possible to reduce accumulation of errors of the motion vector and obtain a high-quality image.

In a third embodiment of the present invention, rounding errors of a motion vector are accumulated with a column of macro blocks, which are arranged in a direction orthogonal to a direction in which image size is reduced, set as one unit. When a cumulative error value exceeds an allowable range, a rounding direction of a motion vector is changed to reduce deviation of the rounding errors. Differences from the first and second embodiments are explained below.

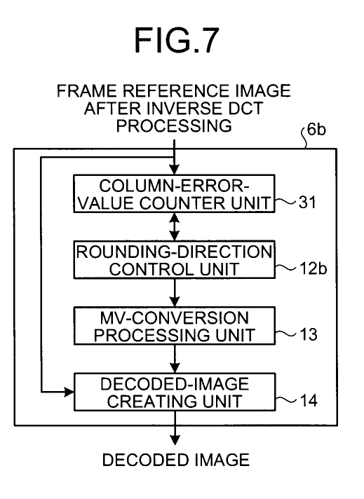

FIG. 7 is a block diagram of a configuration example of a motion compensation unit 6b according to this embodiment. The motion compensation unit 6b includes a column-error-value counter unit 31, a rounding-direction control unit 12b, the MV-conversion processing unit 13, and the decoded-image creating unit 14. The column-error-value counter unit 31 calculates a difference (an error) between a value of a motion vector before being halved and a value obtained by shifting the motion vector after being halved in the left direction by 1 bit and calculates a cumulative value of errors. In this embodiment, macro blocks arranged in one column are treated as one unit. When the horizontal direction (the x direction) of an image is converted into a half size, macro blocks arranged in a direction orthogonal to the horizontal direction are in the column direction (a y direction). The rounding-direction control unit 12b determines a rounding direction of a motion vector based on a comparison result of a cumulative value of errors and a column allowable error range. In this embodiment, the decoding processing device 10 includes the motion compensation unit 6b instead of the motion compensation unit 6 in FIG. 1.

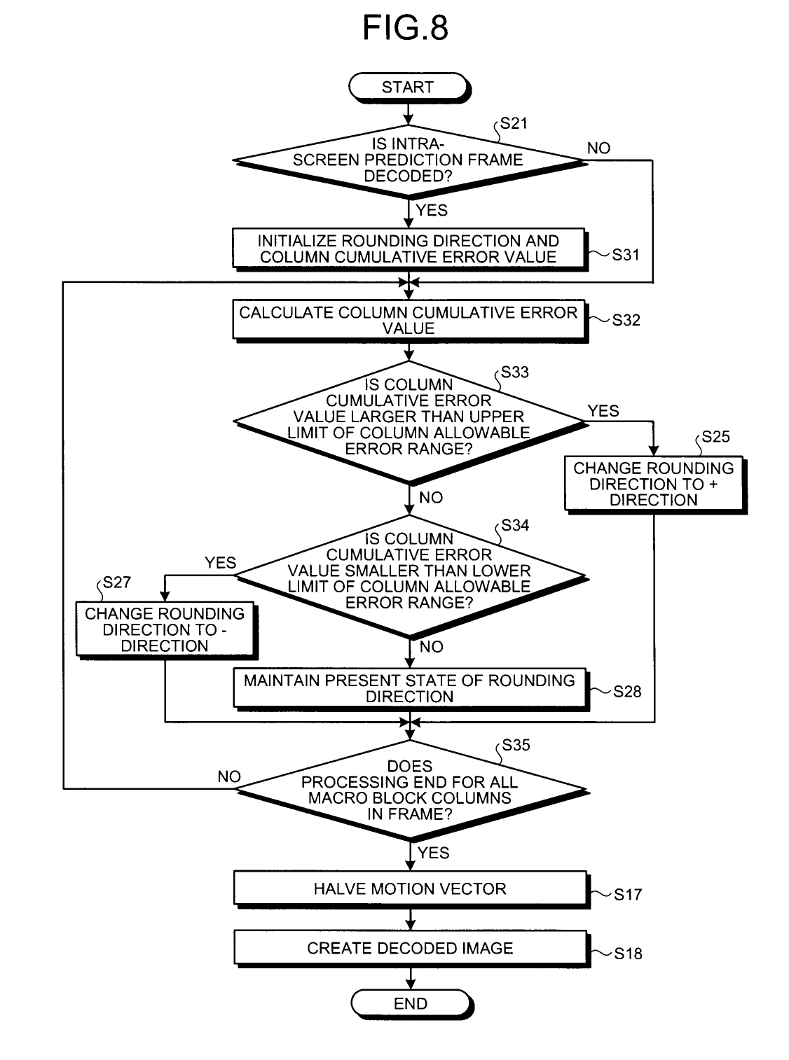

FIG. 8 is a flowchart of motion compensation processing performed by the motion compensation unit 6b according to FIG. 8. First, the column-error-value counter unit 31 checks whether an intra-screen prediction frame is decoded (step S21). When the intra-screen prediction frame is decoded (“Yes” at step S21), the column-error-value counter unit 31 performs initialization of a rounding direction and a column cumulative error value at the start of decoding processing (step S31). As initial setting, the rounding direction is set in the − direction (“roundXDirection=0”). Further, the column-error-value counter unit 31 performs initialization (totalErrorL=0) of a column cumulative error value (totalErrorL) obtained by accumulating a difference (an error) between a value obtained by shifting a motion vector halved in the horizontal direction (mvxh) in the left direction by 1 bit and a value of an original motion vector (mvx) before being halved. When a column of macro blocks is set as one unit, the motion vector treated in this embodiment refers to a motion vector in the macro block column. When the intra-screen prediction frame is not decoded (“No” at step S21), the processing at step S31 is omitted.

As provisional processing, the column-error-value counter unit 31 calculates, after the start of processing for motion compensation, the halved motion vector (mvxh) based on the rounding direction (the − direction) set in the initial setting and calculates a value (mvxh<<1) obtained by shifting the halved motion vector (mvxh) in the left direction by 1 bit. Thereafter, the column-error-value counter unit 31 calculates a difference (mvx−(mvxh<<1)) between the value (mvxh<<1) obtained by shifting the halved motion vector (mvxh) in the left direction by 1 bit and a value of the original motion vector (mvx) before being halved and adds up calculated differences to calculate a column cumulative error value (totalErrorL) (step S32). When notification for changing the rounding direction is received from the rounding-direction control unit 12b, the column-error-value counter unit 31 changes the rounding direction in the processing at step S32 based on the notification.

Subsequently, the rounding-direction control unit 12b compares the column cumulative error value (totalErrorL) calculated by the column-error-value counter unit 31 and a column allowable error range set in advance (steps S33 and S34). The column allowable error range is an allowable range of errors that can be set based on image size, a maximum number of motion vectors, and the like when errors of a motion vector calculated in column units of macro blocks are accumulated.

Specifically, when the column cumulative error value (totalErrorL) is larger than an upper limit of the column allowable error range (“Yes” at step S33), the rounding-direction control unit 12b changes the rounding direction to the + direction (“roundXDirection=1”) (step S25). When the column cumulative error value (totalErrorL) is equal to or smaller than the upper limit of the column allowable error range (“No” at step S33), the rounding-direction control unit 12b determines whether the column cumulative error value (totalErrorL) is smaller than a lower limit of the column allowable error range (step S34). When the column cumulative error value (totalErrorL) is smaller than the lower limit of the column allowable error range (“Yes” at step S34), the rounding-direction control unit 12b changes the rounding direction to the − direction (“roundXDirection=0”) (step S27). When the column cumulative error value (totalErrorL) is equal to or larger than the lower limit of the column allowable error range (“No” at step S34), the rounding-direction control unit 12b does not change the rounding direction and maintains the present state (step S28).

The rounding-direction control unit 12b notifies the column-error-value counter unit 31 and the MV-conversion processing unit 13 of the determined rounding direction of the motion vector. Timing for changing the rounding direction is in column units of macro blocks (when the column cumulative error value (totalErrorL) deviates from the column allowable error range, the rounding direction is changed for a macro block column to be subjected to decoding processing next).

The rounding-direction control unit 12b checks whether the processing (steps S32 to S28) ends for all macro block columns in the frame (step S35). When the processing does not end (“No” at step S35), the rounding-direction control unit 12b repeatedly performs the processing (steps S32 to S28) until the processing ends for all the macro block columns. When the processing ends to all the macro block columns (“Yes” at step S35), the MV-conversion processing unit 13 performs processing for halving the motion vector based on the determination of the rounding direction control unit 12b (step S17).

Processing for outputting the halved motion vector (mvxh) by the MV-conversion processing unit 13 (step S17) and processing for creating a decoded image by the decoded-image creating unit 14 (step S18) are the same as those in the first embodiment.

In this embodiment, when a motion vector is halved, with a column of macro blocks in a frame set as one unit, a rounding direction of the motion vector is changed when predetermined errors are accumulated in a specific direction. Therefore, it is possible to prevent a state in which it looks as if an object in an image suddenly moves when the object moves to an intra-screen prediction frame.

As explained above, in this embodiment, with a column of macro blocks set as one unit, a change of the rounding direction is performed in column units of macro blocks. This makes it possible to perform control (a change of the rounding direction) finer than that in the second embodiment.

In the above explanation, as timing of the initialization performed at the start of the decoding processing, the initialization is performed when the intra-screen prediction frame is decoded. However, the timing is not limited to this. For example, the initialization can be performed every time a frame subjected to the decoding processing is changed.

In the processing explained above, the rounding direction is changed when the column cumulative error value (totalErrorL) deviates from the allowable error range. However, the change of the rounding direction is not limited to this. For example, when the column cumulative error value (totalErrorL) is positive, the rounding direction can be changed to the + direction (“roundXDirection=1”) and, when the column cumulative error value (totalErrorL) is negative, the rounding direction can be changed to the − direction (“roundXDirection=0”). When the column cumulative error value (totalErrorL) is zero, the rounding direction is not changed. Consequently, the rounding direction can be changed to a direction for reducing the cumulative error value. Therefore, it is possible to reduce accumulation of errors of the motion vector and obtain a high-quality image.

In a fourth embodiment of the present invention, rounding errors of a motion vector for each of macro blocks are temporally accumulated. When a cumulative error value exceeds an allowable range, a rounding direction of the motion vector is changed to reduce deviation of the rounding errors. Differences from the first to third embodiments are explained below.

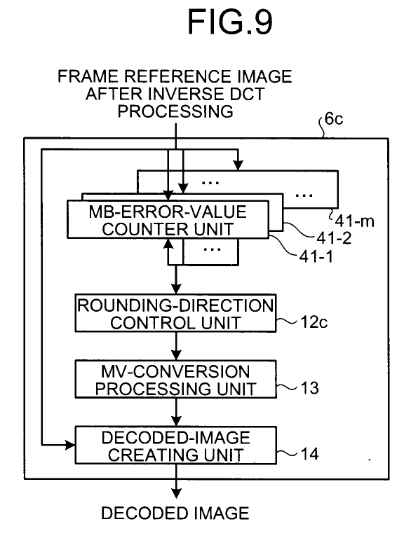

FIG. 9 is a block diagram of a configuration example of a motion compensation unit 6c according to this embodiment. The motion compensation unit 6c includes macro block (MB)-error-value counter units 41-1, 41-2, . . . , and 41-m, a rounding-direction control unit 12c, the MV-conversion processing unit 13, and the decoded-image creating unit 14. Each of the MB-error-value counter units 41-1, 41-2, . . . , and 41-m calculates a difference (an error) between a motion vector before being halved and a value obtained by shifting the motion vector after being halved in the left direction by 1 bit and, for each of macro blocks present in the same position, adds up errors calculated in frames to calculate a cumulative value. In this embodiment, as an example, the number of macro blocks in a frame is set to m. The motion compensation unit 6c includes MB-error-value counter units equivalent to the number of macro blocks (m). The rounding-direction control unit 12c determines a rounding direction of a motion vector based on a comparison result of a cumulative value of errors and an MB allowable error range. In this embodiment, the decoding processing device 10 includes the motion compensation unit 6c instead of the motion compensation unit 6 shown in FIG. 1.

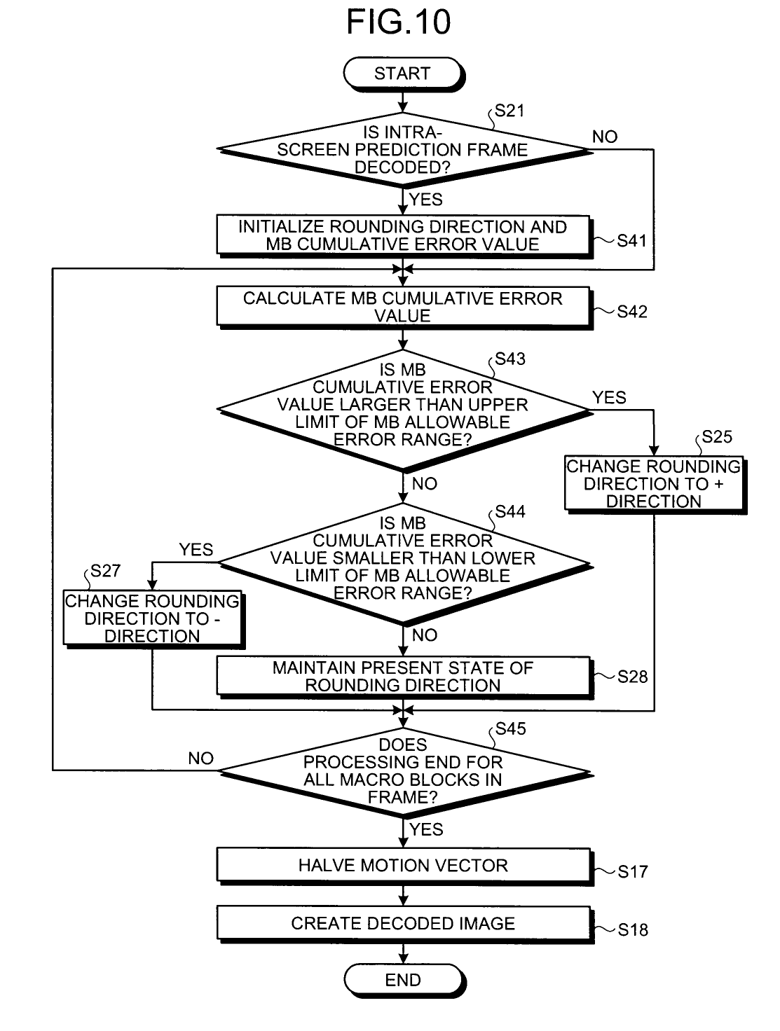

FIG. 10 is a flowchart of motion compensation processing performed by the motion compensation unit 6c according to this embodiment. First, each of the MB-error-value counter units 41-1, 41-2, . . . , and 41-m checks whether an intra-screen prediction frame is decoded (step S21). When the intra-screen prediction frame is decoded (“Yes” at step S21), the MB-error-value counter unit performs initialization of a rounding direction and an MB cumulative error value at the start of decoding processing (step S41). As initial setting, the rounding direction is set in the − direction (“roundXDirection=0”). Further, the MB-error-value counter unit performs initialization (totalError [i]=0) of an MB cumulative error value (totalError [i], 1≦i≦m) obtained by accumulating a difference (an error) between a value obtained by shifting a motion vector halved in the horizontal direction (mvxh) in the left direction by 1 bit and a value of an original motion vector (mvx) before being halved. The MB cumulative error value totalError [i] is an MB cumulative error value in an MB-error-value counter unit 41-i corresponding to an ith macro block. When the intra-screen prediction frame is not decoded (“No” at step S21), the processing at step S41 is omitted.

As provisional processing, the MB-error-value counter unit 41-i calculates, after the start of processing for motion compensation, the halved motion vector (mvxh) based on the rounding direction (the − direction) set in the initial setting and calculates a value (mvxh<<1) obtained by shifting the halved motion vector (mvxh) in the left direction by 1 bit. Thereafter, the MB-error-value counter unit 41-i calculates, for each of motion vectors, a difference (mvx−(mvxh<<1)) between the value (mvxh<<1) obtained by shifting the halved motion vector (mvxh) in the left direction by 1 bit and a value of the original motion vector (mvx) before being halved and adds the calculated difference to an MB error value corresponding to a position of the macro block to calculate an MB cumulative error value (totalError [i]) (step S42). When notification for changing the rounding direction is received from the rounding-direction control unit 12c, the MB-error-value counter unit 41-i changes the rounding direction in the processing at step S42 based on the notification.

Subsequently, the rounding-direction control unit 12c compares the MB cumulative error value (totalError [i]) calculated by the MB-error-value counter unit 31 and an MB allowable error range in each of macro block positions set in advance (steps S43 and S44). The MB allowable error range is an allowable range of errors that can be set based on image size, a maximum number of motion vectors, and the like when errors of a motion vector calculated for each of macro blocks are accumulated for each of macro block positions. The MB allowable error range can be changed for each of macro block positions or can be the same for all macro block positions.

Specifically, when the MB cumulative error value (totalError [i]) is larger than an upper limit of the MB allowable error range (“Yes” at step S43), the rounding-direction control unit 12c changes the rounding direction to the + direction (“roundXDirection=1”) (step S25). When the MB cumulative error value (totalError [i]) is equal to or smaller than the upper limit of the MB allowable error range (“No” at step S43), the rounding-direction control unit 12c determines whether the MB cumulative error value (totalError [i]) is smaller than a lower limit of the MB allowable error range (step S44). When the MB cumulative error value (totalError [i]) is smaller than the lower limit of the MB allowable error range (“Yes” at step S44), the rounding-direction control unit 12c changes the rounding direction to the − direction (“roundXDirection=0”) (step S27). When the MB cumulative error value (totalError [i]) is equal to or larger than the lower limit of the MB allowable error range (“No” at step S44), the rounding-direction control unit 12c does not change the rounding direction and maintains the present state (step S28).

The rounding-direction control unit 12c notifies the MB-error-value counter unit 41 and the MV-conversion processing unit 13 of the determined rounding direction of the motion vector. The change of the rounding direction is performed for each of macro blocks (when the MB cumulative error value deviates from the MB allowable error range, the rounding direction is changed in macro blocks present in the same place of a frame to be subjected to decoding processing next).

The rounding-direction control unit 12c checks whether the processing (steps S42 to S28) ends for all macro blocks in the frame (step S45). When the processing does not end (“No” at step S45), the rounding-direction control unit 12c repeatedly performs the processing (steps S42 to S28) until the processing ends for all the macro blocks (m macro blocks). When the processing ends to all the macro blocks (“Yes” at step S45), the MV-conversion processing unit 13 performs processing for halving the motion vector based on the determination of the rounding direction control unit 12c (step S17). The MV-conversion processing unit 13 can perform, without waiting for the end of the processing for all the macro blocks, the processing for halving the motion vector (step S17) in order from a macro block for which the processing (steps S42 to S28) ends.

Processing for outputting the halved motion vector (mvxh) by the MV-conversion processing unit 13 (step S17) and processing for creating a decoded image by the decoded-image creating unit 14 (step S18) are the same as those in the first embodiment.

In this embodiment, when a motion vector is halved, errors are temporally accumulated for each of macro blocks in the same position and, when predetermined errors are accumulated in a specific direction, the rounding direction of the motion vector is changed. Therefore, it is possible to prevent a state in which it looks as if an object in an image suddenly moves when the object moves to an intra-screen prediction frame.

In this case, as in the embodiments explained above, it is possible to reduce accumulation of errors of the motion vector without increasing a calculation amount and obtain a high-quality image while maintaining the accuracy of the motion vector.

The unit for accumulating temporal errors in the same position is not limited to the macro block. As in the third embodiment, a macro block column can be a unit.

In the processing explained above, the rounding direction is changed when the MB cumulative error value (totalError [i]) deviates from the allowable error range. However, the change of the rounding direction is not limited to this. For example, when the MB cumulative error value (totalError [i]) is positive, the rounding direction can be changed to the + direction (“roundXDirection=1”) and, when the MB cumulative error value (totalError [i]) is negative, the rounding direction can be changed to the − direction (“roundXDirection=0”). When the MB cumulative error value (totalError [i]) is zero, the rounding direction is not changed. Consequently, the rounding direction can be changed to a direction for reducing the cumulative error value. Therefore, it is possible to reduce accumulation of errors of the motion vector and obtain a high-quality image.

In a fifth embodiment of the present invention, a rounding error of a motion vector for each of macro blocks in an entire frame is accumulated and a rounding direction in which the rounding error decreases is selected. Differences from the first embodiment are explained.

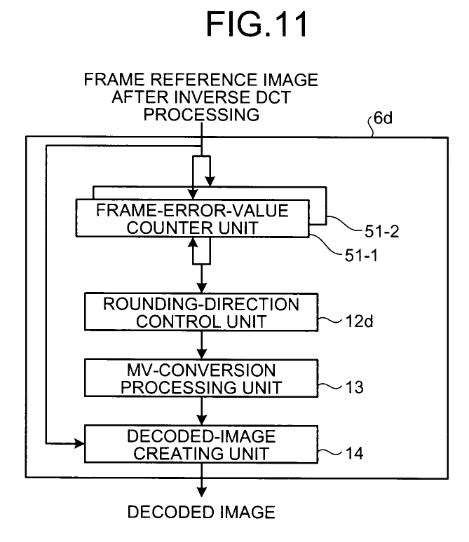

FIG. 11 is a block diagram of a configuration example of a motion compensation unit 6d according to this embodiment. The motion compensation unit 6d includes frame-error-value counter units 51-1 and 51-2, a rounding-direction control unit 12d, the MV-conversion processing unit 13, and the decoded-image creating unit 14. When the rounding processing is performed in the + direction, the frame-error-value counter unit 51-1 calculates a difference (an error) between a value of a motion vector before being halved and a value obtained by shifting the motion vector after being halved in the left direction by 1 bit and calculates a cumulative value of errors. When rounding processing is performed in the − direction, the frame-error-value counter unit 51-2 calculates a difference (an error) between a value of a motion vector before being halved and a value obtained by shifting the motion vector after being halved in the left direction by 1 bit and calculates a cumulative value of errors. The rounding-direction control unit 12d compares the cumulative error value obtained when the motion vector is rounded in the + direction and the cumulative error value obtained when the motion vector is rounded in the − direction and selects a smaller one. In this embodiment, the decoding processing device 10 includes the motion compensation unit 6d instead of the motion compensation unit 6 shown in FIG. 1.

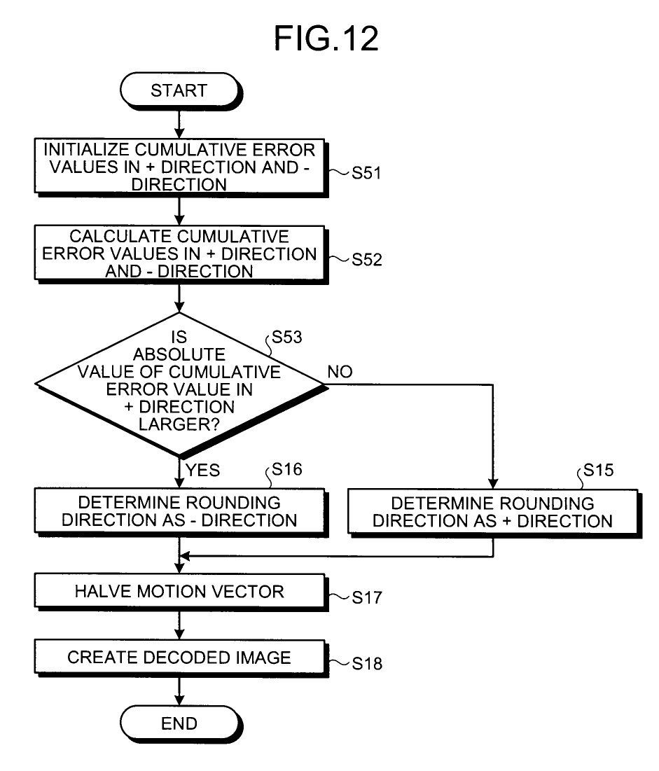

FIG. 12 is a flowchart of motion compensation processing performed by the motion compensation unit 6d according to this embodiment. First, the frame-error-value counter unit 51-1 performs, at the start of decoding processing, initialization (totalError1=0) of a cumulative error value (totalError1) obtained by accumulating a difference (an error) between a value obtained by shifting a motion vector halved in the horizontal direction (mvxh) in the left direction by 1 bit and a value of an original motion vector (mvx) before being halved (step S51). Similarly, the frame-error-value counter unit 51-2 performs initialization (totalError0=0) of a cumulative error value (totalError0) obtained by accumulating the difference (the error) (step S51). The initialization processing is performed every time a frame for which inter-screen prediction is performed is changed.

After the start of the motion compensation processing, the frame-error-value counter unit 51-1 performs rounding processing in the + direction as provisional processing to calculate a halved motion vector (mvxh) and calculates a value mvxh<<1) obtained by shifting the halved motion vector (mvxh) in the left direction by 1 bit. Thereafter, the frame-error-value counter unit 51-1 calculates, for each of motion vectors of a macro block, a difference (mvx−(mvxh<<1)) between the value (mvxh<<1) obtained by shifting the halved motion vector (mvxh) in the left direction by 1 bit and a value of the original motion vector (mvx) before being halved and adds up calculated differences to calculate the cumulative error value (totalError1) in the + direction (step S52). Similarly, the frame-error-value counter unit 51-2 calculates the cumulative error value (totalError0) in the − direction obtained when the rounding processing is performed in the − direction (step S52).

Subsequently, the rounding-direction control unit 12d compares the cumulative error value (totalError1) calculated by the frame-error-value counter unit 51-1 and the cumulative error value (totalError0) calculated by the frame-error-value counter unit 51-2 (step S53). Specifically, when an absolute value of the cumulative error value (totalError1) is larger than an absolute value of the cumulative error value (totalError0) (an absolute value of the cumulative error value in the + direction is larger than that in the − direction) (“Yes” at step S53), the rounding-direction control unit 12d determines the rounding direction as the − direction (“roundXDirection=0”) (step S16). When the absolute value of the cumulative error value (totalError1) is equal to or smaller than the absolute value of the cumulative error value (totalError0) (the absolute value of the cumulative error value in the − direction is larger or the same as that in the + direction) (“No” at step S53), the rounding-direction control unit 12d determines the rounding direction as the + direction (“roundXDirection=1”) (step S15). The rounding-direction control unit 12d notifies the MV-conversion processing unit 13 of the determined rounding direction of the motion vector.

Processing for outputting the halved motion vector (mvxh) performed by the MV-conversion processing unit 13 (step S17) and processing for creating a decoded image performed by the decoded-image creating unit 14 (step S18) are the same as those in the first embodiment.

In this embodiment, when a motion vector is halved, errors are respectively calculated, for each of frames, for the rounding processing performed in the + direction and the rounding processing performed in the − direction. The rounding direction in which the cumulative error value is smaller is selected. Therefore, it is possible to select an optimum rounding direction for each of frames and prevent a state in which it looks as if an object in an image suddenly moves when the object moves to an intra-screen prediction frame.

As explained above, in this embodiment, in each of frames, the rounding processing is performed in the + direction and the − direction when the motion vector is reduced. Cumulative values of errors that occur in the directions are compared. This makes it possible to select a direction of the rounding processing in which a cumulative error value surely decreases.

The motion vector is not limited to a motion vector in macro block units and can be motion vectors in units of other areas such as a sub-macro block.

Besides the kinds of the motion compensation processing in the embodiments explained above, the kinds of the motion compensation processing in the embodiments can be combined. The units for changing the rounding direction are not limited to macro block units and column units and can be slice units and screen area units.

The processing for halving an image is explained in the embodiments. However, the present invention is not limited to this and can also be applied to other scales. Further, the processing for reducing an image in the horizontal direction (the x direction) is explained in the embodiments. However, the present invention can also be applied to processing for reducing an image in other directions.

The embodiments are explained by using the term “intra-screen prediction frame”. However, the present invention is not limited to ISO/IEC14496-10 (H.264). The present invention can also be applied to ISO/IEC13818-2 (MPEG2) and ISO/IEC14496-2 (MPEG4) by reading the intra-screen prediction frame as intra-frame.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A motion compensation device applicable to a decoding processing device that performs decoding processing using a reference image having size different from size during encoding, the motion compensation device comprising:
a counter unit that counts a number of input frames;
a rounding-direction control unit that determines, in reducing a motion vector, based on whether the number of counts by the counter unit is odd or even, a rounding direction of rounding processing for converting a value of the motion vector into specified accuracy;
a motion vector (MV)-conversion processing unit that reduces the motion vector and applies, based on the rounding direction determined by the rounding-direction control unit, the rounding processing to a value of the motion vector after the reduction; and
a decoded-image creating unit that creates a predicted image using the motion vector after the rounding processing and a decoded image in the past, which is the reference image, and creates a decoded image based on the predicted image.

2. The motion compensation device according to claim 1, wherein the rounding-direction control unit determines the rounding direction as a + direction when the number of counts is an odd number and determines the rounding direction as a − direction when the number of counts is an even number.

3. The motion compensation device according to claim 1, wherein the rounding-direction control unit determines the rounding direction as a − direction when the number of counts is an odd number and determines the rounding direction as a + direction when the number of counts is an even number.

4. A motion compensation device applicable to a decoding processing device that performs decoding processing using a reference image having size different from size during encoding, the motion compensation device comprising:
an error-value counter unit that calculates a difference between a value obtained by shifting a reduced motion vector to accuracy before the reduction and a value of the motion vector before the reduction and calculates a cumulative value of the difference;
a rounding-direction control unit that determines, in reducing a motion vector, based on the cumulative value of the difference calculated by the error-value counter unit, a rounding direction of rounding processing for converting a value of the motion vector into specified accuracy;
a motion vector (MV)-conversion processing unit that reduces the motion vector and applies, based on the rounding direction determined by the rounding-direction control unit, the rounding processing to a value of the motion vector after the reduction; and
a decoded-image creating unit that creates a predicted image using the motion vector after the rounding processing and a decoded image in the past, which is the reference image, and creates a decoded image based on the predicted image.

5. The motion compensation device according to claim 4, wherein the motion vector is a motion vector in macro block units.

6. The motion compensation device according to claim 4, wherein the motion vector is a motion vector in sub-macro block units.

7. The motion compensation device according to claim 4, wherein the motion vector is a motion vector in macro block column units.

8. The motion compensation device according to claim 4, wherein the motion vector is a motion vector in slice units.

9. The motion compensation device according to claim 4, wherein the rounding-direction control unit determines the rounding direction of the rounding processing for the motion vector to be a same direction in a same frame.

10. The motion compensation device according to claim 5, wherein the rounding-direction control unit determines, in macro block units, the rounding direction of the rounding processing for the motion vector.

11. The motion compensation device according to claim 7, wherein the rounding-direction control unit determines, in macro block column units, the rounding direction of the rounding processing for the motion vector.

12. The motion compensation device according to claim 11, wherein the error-value counter unit sets timing of initialization performed at start of decoding processing to time when an intra-screen prediction frame is decoded.

13. The motion compensation device according to claim 11, wherein the error-value counter unit sets timing of initialization performed at start of decoding processing to time when a frame to be subjected to the decoding processing is changed.

14. The motion compensation device according to claim 4, wherein the error-value counter unit calculates, in frames different from each other, a difference between a value obtained by shifting a reduced motion vector in macro block units to accuracy before the reduction and a value of the motion vector before the reduction and accumulates the calculated difference for each of positions of a same macro block in the respective frames to calculate a cumulative value of differences.

15. The motion compensation device according to claim 14, wherein the rounding-direction control unit determines, in macro block unit, the rounding direction of the rounding processing for the motion vector.

16. A motion compensation device applicable to a decoding processing device that performs decoding processing using a reference image having size different from size during encoding, the motion compensation device comprising:
an error-value counter unit that, as rounding processing for converting a value of a motion vector into specified accuracy, calculates, concerning two rounding directions in rounding a value of the motion vector in a + direction and rounding the value in a − direction, a difference between a value obtained by shifting a reduced motion vector to accuracy before the reduction and a value of the motion vector before the reduction and calculates a cumulative value of the difference;
a rounding-direction control unit that determines, in reducing the motion vector, based on an absolute value of the cumulative value of the difference calculated when the rounding processing is performed in the + direction and an absolute value of the cumulative value of the difference calculated when the rounding processing is performed in the − direction;
a motion vector (MV)-conversion processing unit that reduces the motion vector and applies, based on the rounding direction determined by the rounding-direction control unit, the rounding processing to a value of the motion vector after the reduction; and
a decoded-image creating unit that creates a predicted image using the motion vector after the rounding processing and a decoded image in the past, which is the reference image, and creates a decoded image based on the predicted image.

17. The motion compensation device according to claim 16, wherein the motion vector is a motion vector in macro block units.

18. The motion compensation device according to claim 16, wherein the motion vector is a motion vector in sub-macro block units.

19. The motion compensation device according to claim 16, wherein the motion vector is a motion vector in macro block column units.

20. The motion compensation device according to claim 16, wherein the motion vector is a motion vector in slice units.
